(19) United States
(12) Patent Application Publication
(10) Pub. No.: US 2002/0019314 A1
(43) Pub. Date: Feb. 14, 2002

(54) Combinations of crop protection agents with cationic polymers

(76) Inventors: Gerhard Frisch, Wehrheim (DE); Julio Martinez de Una, Liederbach (DE); Udo Bickers, Wietmarschen (DE); Erwin Hacker, Hochheim (DE); Hans Philipp Huff, Eppstein (DE); Gerhard Schnabel, Elsenfeld (DE)

Correspondence Address: FROMMER LAWRENCE & HAUG LLP, 745 Fifth Avenue, New York, NY, 10151, US

(21) Appl. No.: 09/852,104

(22) Filed: May 9, 2001

(30) Foreign Application Priority Data
May 11, 2000 (DE) 10022987.5

(51) Int. Cl. A01N 25/00

(52) U.S. Cl. 504/358; 514/788

(57) ABSTRACT

The present invention relates to the combination of a combination of an anionic agrochemically active compound with a cationic polymer with formation of electrostatic interaction for the controlled release of this active compound. This polymer preferably contains cationic quaternary nitrogen atoms. The combinations according to the invention or agrochemical formulations containing these combinations permit the suppression of antagonistic interactions between different active compounds and an increase in the crop selectivity of individual active compounds.

The present invention relates to combinations of crop protection agents with polymeric cationic auxiliaries which permit a controlled release of an active compound. The combinations can be used to increase crop selectivities and to reduce antagonisms and give particularly good results in the case of herbicides, in particular in the case of mixtures of herbicides with growth regulators and safeners.

It is known that various application problems, reduced activity owing to antagonistic interactions between two or more active compounds and insufficient so-called crop compatibility and associated undesirable damage to the plants can occur during the application of various agrochemical products, for example herbicides, fungicides, insecticides, plant growth regulators, safeners or fertilizers. It is furthermore known that these phenomena are frequently observed during so-called foliar application, and again in particular in the case of herbicides or else of mixtures of herbicides with safeners and/or growth regulators.

To avoid these problems, a so-called split application, for example, or an overdosage of the active compound that is antagonized has been recommended for cases of reduced activity owing to antagonism. In cases of poor selectivity or insufficient crop compatibility, it is often likewise possible to use split application; an alternative option is underdosage. However, for various reasons, all of these procedures are rather unattractive and uneconomical. When using split application, the active compound formulation has to be applied at least twice; this is time-consuming and labor-intensive. Overdosage of an active compound results in additional expenditure, underdosage involves the risk of reduced yields owing to insufficient control of harmful organisms.

U.S. Pat. No. 5,428,000 discloses active compound compositions comprising a herbicide for broad-leaved weeds and a herbicide for weed grasses. The herbicide for weed grasses has a neutral charge; in contrast, the herbicide for broad-leaved weeds is of anionic nature and is present in combination with a hydrophilic polymer, the polymer being a copolymer formed from an ammonium-containing compound and a compound which does not contain any ammonium. The ammonium-containing compound is generally derived from aromatic and nonaromatic nitrogen heterocycles, ammonium derivatives of acrylic acid and benzylammonium compounds. Thus, the polymers are exclusively polymers in which the quaternary nitrogen atom is not contained in the main chain of the polymer. The hydrophilic polymers used are exclusively copolymers of the abovementioned type. The herbicides for weed grasses used are sethoxydim, alloxidim, fluazifop, quizalofop or fenoxaprop; for broad-leaved weeds, the use of bentazone, imazaquin, acifluorfen, fomesafen, chlorimuron, imazethapyr, thifensulfuron and 2,4-D has been described.

DE 198 33 066 discloses aqueous dispersions of polymers with cationic functionality and redispersible powders obtainable from the dispersions, and also their use, inter alia for the delayed release of active compounds of any kind.

It is an object of the present invention to provide formulations of crop protection agents which render split applications and the requirement of over- or underdosage obsolete.

This object is achieved by a combination of at least one anionic agrochemically active compound, in particular a herbicide, with a cationic polymer with formation of electrostatic interaction between these components for the controlled release of active compound, wherein all or at least some of this polymer is constructed of monomers having cationic groups which contain in particular quaternary nitrogen atoms, where the percentage of monomer units which do not contain any cationic groups, in particular no quaternary nitrogen atoms, is at most 90% by weight, preferably at most 50% by weight, and the molecular weight M_{N} of the polymers is <10 000 if the quaternary nitrogen atoms are arranged exclusively outside the main chain of the polymer.

It has been found that problems such as poor selectivity and insufficient crop compatibility or reduced activity caused by antagonism can be avoided by combining certain cationic polymers with one or more agrochemically active compounds.

The present invention furthermore provides the application of the combination according to the invention for controlling undesirable harmful organisms, in particular undesirable grasses and broad-leaved weeds.

In the present invention, the term “polymer” includes both oligomers and polymers of the corresponding monomers, i.e. molecules having a low degree of polymerization and also those having a high degree of polymerization. The molecular weights MN of the compounds which can be used according to the invention as polymers are at least about 500.

In the polymer/active compound combination according to the invention, some or all of the agrochemically active compound enters into an attractive reversible intermolecular interaction with the polymer. These interactions are electrostatic interactions. The agrochemically active compound can be an active compound having partial selectivity. Alternatively, it is also possible for an active compound which, in an intended active compound mixture, shows antagonistic action, to interact with the polymer. It is also possible for two or more active compounds in an active compound mixture to enter into such an interaction.

The polymers to be used according to the invention can also be surfactants. Owing to their physicochemical properties, they can be dispersed, emulsified or dissolved in water or organic solvents. The polymers are preferably dissolved, the preferred solvents being polar protic and polar aprotic organic solvents and water. Most preferably, the polymers dissolve in water.

Polymers suitable for the combinations according to the invention preferably penetrate only slowly, if at all, into the harmful organism, penetration generally taking place, for example, via the leaf or the root. In general, the absorption or penetration rate of the polymers used according to the invention is between <0.01 % and 80%, preferably considerably less than 50%, in 24 hours.

The polymers used according to the invention have suitable stable cationic groups which are preferably selected from the group of the so-called onium functions. Suitable onium groups include phosphonium, ammonium and sulfonium groups. Preference according to the invention is given to ammonium functions. These have nitrogen atoms with a positive charge, generally quaternary nitrogen atoms. Quaternary nitrogen atoms are to be understood as meaning nitrogen atoms having a total of four valence bonds to the attached atoms, where, for example, four single bonds, but also two single and one double bond, may be present.

In general, the mean molecular weight M_{N}, which is also to be understood as such above, of the polymers used according to the invention is about >500, preferably from about 1 000 to 1 000 000. The polymers in question can be homo- or copolymers and are produced in customary polymerization reactions, for example polyadditions, polycondensations, free-radical and ionic polymerizations and metal-complex-catalyzed polymerizations. Also suitable are modified or unmodified natural polymers, for example oligo- and polypeptides and oligo- and polysaccharides.

The quaternary cationic nitrogen atom in the ammonium-group-containing polymers which are preferably used according to the invention can be located outside the main chain of the polymer, i.e. outside of the chain which forms the backbone of the molecule. Examples of preferred polymers of this type are polymers containing monomer units of the formula (I) below.

[chemical structure]

In this formula, R¹ and R² are independently of one another selected from the group consisting of hydrogen, linear and branched C₁-C₈-alkyl radicals, linear and branched C₁-C₅-alkylol radicals, cyclopentyl and cyclohexyl radicals. An example of such a polymer is Genamin® PDAC (R¹, R²═Me) from Clariant GmbH.

A further preferred polymer of this type contains the monomer units shown in formula (II) below.

[chemical structure]

In formula (II), n is an integer from 1 to 10, preferably from 2 to 5, and the substituents R¹ to R³ are independently of one another selected from the group consisting of hydrogen, linear and branched C₁-C₈-alkyl groups, linear and branched C₁-C₅-alkylol groups, cyclopentyl and cyclohexyl groups.

The quaternary cationic nitrogen atom may also be located in the main chain of the polymer. Such polymers are preferred in the context of the present invention. Suitable polymers with cationic nitrogen atoms in the main chain are, for example, those of the formula (III) below

[chemical structure]

in which n is an integer from 3 to 50, preferably on average 6, or of the formula (IV) below

[chemical structure]

in which n is an integer from 10 to 200, preferably on average 100.

Polymers of this type are available from Rhodia GmbH under the name Mirapol®, for example as Mirapol® WT (formula III) and Mirapol AD-1 (formula IV).

In the formulae (I) to (IV), X⁻ is an anion of an acid of inorganic or organic origin, examples including carboxylates, for example acetate, sulfate, carbonate, sulfonate and halide.

Further suitable polymers containing cationic nitrogen atoms are known to the person skilled in the art. In general, commercial products will be employed.

The polymers used can also be copolymers of monomers containing quaternary nitrogen atoms with monomers containing no quaternary nitrogen atoms. The percentage of monomers which do not contain any quaternary nitrogen atoms is at most 90% by weight, preferably at most 50% by weight, of the polymer.

If the polymers used in the present invention are polymers in which the cationic nitrogen atoms are located exclusively outside the main chain of the polymer, the molecular weight MN of this polymer is preferably <10 000.

Furthermore, if a polymer is used in which the cationic nitrogen atoms are located exclusively outside of the main chain of the polymer, the polymer preferably comprises exclusively monomers containing quaternary nitrogen atoms, for example exclusively monomer units of the formula (I) or of the formula (II) or copolymers thereof.

Agrochemically active compounds suitable for the present invention have functional groups which are negatively charged or carry a negetive partial charge and can be converted into anionic functions. It is also possible for the active compounds to be present as anions even before the formulation. However, it is also possible that these active compounds are converted into anions only during the formulation or the preparation of the so-called tank mix, for example by abstraction of an acidic hydrogen atom during these processes.

Anionic active compounds suitable for use in the combinations according to the invention are preferably the agrochemically active compounds which belong to the group of the herbicides, fungicides, insecticides, growth regulators, safeners, molluscicides, acaricides and nematicides.

Particularly suitable for combination with the cationic polymers used according to the invention are herbicides, and among these in particular acetolactate synthase (ALS) inhibitors, such as, for example, sulfonylureas and salts thereof, hydroxy-benzonitriles, such as, for example bromoxynil and ioxynil, and salts thereof, bentazone, so-called aryloxyalkylcarboxylic acid and derivatives thereof, such as esters or salts, and esters, such as MCPA, 2,4-D, CMPP, 2,4-DP, 2,4-DB, so-called (hetero)aryloxyaryloxyalkylcarboxylic acids and salts and esters thereof, such as, for example, fenoxaprop-p-ethyl, and salts and esters thereof, dichlofop-methyl, clodinafop-propargyl, fluazifop, HPPDO inhibitors or salts thereof, such as, for example, mesotrione, sulcotrione; triazines; cyclohexanedione oximes or salts thereof, such as, for example, sethoxidim, clethodim or trialkoxidim; growth regulators or hormone-like substances, such as, for example, indolylacetic acid or indolylbutyric acid or auxins; safeners, such as, for example, mefenpyr-diethyl and 5,5-biphenyl-2-isoxazoline-3-carboxylic acid.

Most suitable for combination with the cationic nitrogen-containing polymers used according to the invention are sulfonylureas of the formula (V)

[chemical structure]

In the formula (V), M^{⊕} is a suitable cation, preferably an alkali metal ion or an ammonium ion, which may or may not contain organic substituents, most preferably an Na, K, ammonium, tetralkylammonium, tetraalkylolammonium or mono-, di- or trialkylammonium ion,

R′ is hydrogen or a (C₁-C₁₀)-alkyl radical, preferably hydrogen or methyl,

R is a radical selected from the group consisting of the compounds corresponding to formulae (Va) to (Vf)

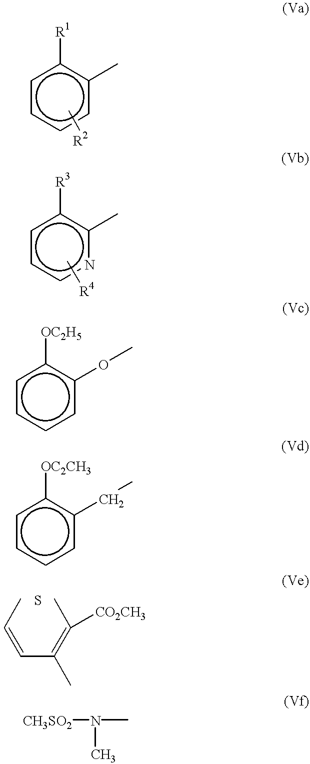

in which R¹ is selected from the group consisting of —CO₂(C₁-C₁₀-alkyl), CO₂CH₂

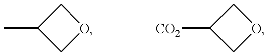

—CO₂N(C₁-C₁₀-alkyl), SO₂(C₁-C₄-alkyl), CF₃, —O(C₁-C₁₀-alkyl), —OCH₂CH₂Cl, CH₂CH₂CF₃, halogen, preferably Cl or F,

R², R³, R⁴, independently of one another are H, CH₃, —OH, —O(C₁-C₁₀-alkyl), —NH(C₁-C₁₀-alkyl), —N(C₁-C₁₀-alkyl)₂, NHCHO, —NHCO₂(C₁-C₁₀-alkyl), —CH₂NHSO₂CH₃, halogen, preferably F, Cl, Br or I,

Het is a radical of the formula (Vg)

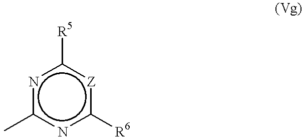

in which R⁵, R⁶ independently of one another are halogen, preferably F or Cl, —O(C₁-C₄-alkyl), C₁-C₄-alkyl, —NH(C₁-C₄-alkyl), —N(C₁-C₄-alkyl)₂, —OCH₂CF₃, —OCHCl₂, and

Z is N or a CH group.

In the case of all the abovementioned agrochemically active compounds it is, of course, also possible, if appropriate, to use the corresponding active compound derivatives known to the person skilled in the art as being suitable for use, such as acids, esters or salts.

The combinations according to the invention permit the phytotoxic potential of active compounds to be reduced and antagonization of other active compounds in mixtures with the former to be suppressed. Active compounds to be combined according to the invention can therefore be used together with other active compounds or as only active compound, if appropriate together with customary additives and adjuvants. Examples of preferred combinations according to the invention are described below. In all these combinations, the use of the active compounds described above as being particularly suitable or most suitable is, of. course, likewise preferred, even if this is not explicitly mentioned.

The combinations according to the invention are prepared by the customary processes known to the person skilled in the art. These processes are, for example, stirring, dissolving and/or grinding of the components.

The agrochemically active compounds combined with the polymers used according to the invention can be formulated with other active compounds which, if appropriate, are likewise combined with polymers according to the present invention, to afford mixtures giving advantageous results.

A preferred embodiment of the present invention are combinations in which some or all of an agrochemically active compound, for example a herbicide, is combined according to the invention with a cationic polymer, the combination additionally comprising at least one further agrochemically active compound, for example a herbicide or safener.

In a further preferred embodiment of the present invention, herbicides with safeners and/or growth regulators are formulated in combination with the polymers used according to the invention, where at least one of the agrochemically active compounds has been partially or fully combined according to the invention with these polymers.

A further preferred embodiment of the combination according to the invention comprises mixtures of one or more graminicides with one or more herbicides which preferably act against dicotyledonous weeds, where at least one of the agrochemically active compounds has been partially or fully combined according to the invention.

In a further preferred embodiment of the combination according to the invention, one or more graminicides are mixed with a safener, where at least one of the agrochemically active compounds has been partially or fully combined according to the invention.

According to the present invention, it is furthermore preferred to combine one or more herbicides having a rapid mechanism of action with one or more herbicides having a relatively slow mechanism of action, where at least one of the agrochemically active compounds has been partially or fully combined according to the invention.

Finally, preference is given to partially or fully combining according to the invention acetolactate synthase inhibitors, in particular sulfonylureas, to increase crop selectivity.

In the combinations according to the invention, the weight ratio of polymer to anionic active compound or compounds is, depending on the molecular weight of the monomer and the active compound and on other physicochemical parameters known to the person skilled in the art, from 0.001:1 to 1:0.001, preferably from 0.01:1 to 1:0.01, most preferably from 0.1:1 to 1:0.1.

In many cases, it is advantageous to add adjuvants or adjuvant mixtures, for example of oils, solvents, surfactants or surfactant mixtures. Here, adjuvants are to be understood as meaning those additives to active compound/polymer combinations which are not active themselves but enhance the properties of the active compound. Suitable adjuvants are nonionic surfactants, for example those of the formula RO(CH₂CH₂O)ₙH, in which R is a (C₁₀-C₂₂)-fatty alcohol radical, a tristyrylphenol radical, a tributylphenol radical, a (C₁-C₁₄)-alkylphenol radical, a tridecyl alcohol radical, a glyceride radical or a radical derived from castor oil and n is an integer of from 1 to 500, preferably from 3 to 200.

Such substances are obtainable, for example, as Genapol®, Sapogenat® and Arkopale series from Clariant GmbH and as Soprophor® series from Rhodia GmbH. It is also possible to employ block copolymers based on ethylene oxide, propylene oxide and/or butylene oxide, for example the compounds sold by BASF AG under the names Pluronics® or Tetronics®.

Anionic or betainic surfactants, too, can be used. Examples of anionic surfactants include calcium dodecylbenzylsulfonate, succinates, phosphated, sulfated and sulfonated nonionic surfactants, for example those of the type mentioned above, and sorbitates, these anionic compounds being neutralized with alkali metal, alkaline earth metal or ammonium ions. Such surfactants are available, for example, under the name Genapol® LRO (Clariant GmbH).

Betainic surfactants are obtainable, for example, from Goldschmidt AG under the name Tegotain®.

Also suitable are cationic surfactants, for example those based on quaternary ammonium, phosphonium and tertiary sulfonium salts, for example Atlas® G3634 A from Uniquema.

The amount of surfactant used is from 10 to 2 000 g/ha, preferably from 50 to 2 000 g/ha. The addition of nitrogen, for example in the form of urea, ammonium nitrate, ammonium sulfate, ammonium hydrogen sulfate or mixtures thereof, is likewise often advantageous.

Formulations comprising combinations according to the invention are described in an exemplary manner below.

It is possible to use polymers containing monomers of the formulae (I)-(IV) together with acetolacetate synthase (ALS) inhibitors, preferably sulfonylureas of the formula (V), to improve crop compatibility, such as in crops of corn, wheat, barley, rice, soyabeans, sugar beet or cotton.

It is also possible to significantly increase the compatibility of iodosulfurons at an application rate of from 1 to 10 g/ha by combination with polymers of the Mirapol® type from Rhodia GmbH in a weight ratio of preferably from 0.1:1 to 1:0.1 in crops such as corn or wheat.

Even any antagonistic action of anionic agrochemically active compounds, in particular of herbicides which act against weeds, such as, for example, sulfonylureas or salts thereof, hydroxybenzonitriles such as bromoxynil and salts thereof, ioxynil and salts thereof, aryloxyalkylcarboxylic acids and salts thereof or bentazone on graminicides, for example fenoxaprop-P-ethyl, can be reduced or prevented by using polymers having cationic functional groups. For example, the simultaneous application of fenoxyprop-P-ethyl (30-90 g/ha), bromoxynil potassium (150-600 g/ha) and a polyanion, for example Mirapol® (50-5 000 g/ha, preferably 50-2 000 g/ha) results in a considerably better control of grasses than a corresponding application without a polymer. Further substances which may optionally be present are safeners, other herbicides, adjuvants such as, for example, Genapol® LRO or fertilizers, such as, for example, ammonium sulfate, ammonium hydrogen sulfate, urea or ammonium nitrate.

The situation in the case of the active compound combination fenoxaprop-P-ethyl (30-90 g/ha), iodosulfuron-methyl sodium (2-10 g/ha) and mefenpyr-diethyl (10-60 g/ha) is similar. By adding suitable polymers, for example of the Mirapol® type (1-50 g/ha), it is possible to reduce any antagonism considerably. Further substances which may optionally be present are safeners, other herbicides, adjuvants such as, for example, Genapol® LRO or fertilizers, such as, for example, ammonium sulfate, ammonium hydrogen sulfate, urea or ammonium nitrate.

To reduce the phytotoxic potential and to increase the selectivity in crop plants such as, for example, wheat, rice and corn it is possible to combine ALS inhibitors, in particular sulfonylureas and salts thereof (for example iodosulfuron, metsulfuron or rimsulfuron) with known polymers of the Mirapol® series from Rhodia GmbH or the Genamin® series from Clariant GmbH. Further substances which may optionally be present are safeners, other herbicides, adjuvants such as, for example, Genapol® LRO or fertilizers, such as, for example, ammonium sulfate, ammonium hydrogen sulfate, urea or ammonium nitrate.

To prevent any reduced action of graminicides owing to antagonism, ALS inhibitors, in particular sulfonylureas and salts thereof (for example iodosulfuron, metsulfuron, rimsulfuron) can be mixed for application with known polymers, for example of the Mirapol® series from Rhodia GmbH or of the Genamin® series from Clariant GmbH or comparable polymers and with graminicides, for example fenoxaprop-P-ethyl. Further substances which may optionally be present are safeners, other herbicides, adjuvants such as, for example, Genapol® LRO or fertilizers, such as, for example, ammonium sulfate, ammonium hydrogen sulfate, urea or ammonium nitrate.

To prevent any reduced action of graminicides owing to antagonistic interactions with so-called aryloxyalkylcarboxylic acids, for example 2,4-D, the aryloxyalkyl-carboxylic acids are, for application, combined with cationic polymers of the Mirapol® series from Rhodia GmbH or of the Genamin® series from Clariant GmbH and then mixed with the graminicide, for example fenoxaprop-P-ethyl. Further substances which may optionally be present are safeners, other herbicides, adjuvants such as, for example, Genapol® LRO or fertilizers, such as, for example, ammonium sulfate, ammonium hydrogen sulfate, urea or ammonium nitrate.

For application, bromoxynil or ioxynil or salts thereof can be combined with cationic polymers of the Mirapol® series from Rhodia GmbH or of the Genamin® series from Clariant GmbH and mixed with graminicides, for example fenoxaprop-P-ethyl, clodinafop-propargyl, clethodim or setoxidim, to suppress antagonistic interactions. Further substances which may optionally be present are safeners, other herbicides, adjuvants such as, for example, Genapole LRO or fertilizers, such as, for example, ammonium sulfate, ammonium hydrogen sulfate, urea or ammonium nitrate.

For application, mixtures of ALS inhibitors, in particular of sulfonylureas such as, for example, iodosulfuron, metsulfuron or rimsulfuron, with bromoxynil or salts thereof, are combined with cationic polymers of the Mirapol® series from Rhodia GmbH or of the Genamin® series from Clariant GmbH. Mixtures of this combination with graminicides, for example fenoxaprop-P-ethyl, clodinafop-propagyl or clethodim, have reduced antagonistic action. Further substances which may optionally be present are safeners, other herbicides, adjuvants such as, for example, Genapol® LRO or fertilizers, such as, for example, ammonium sulfate, ammonium hydrogen sulfate, urea or ammonium nitrate. For application, mixtures of ALS inhibitors, in particular sulfonylureas such as, for example, iodosulfuron, metsulfuron or rimsulfuron, with so-called aryloxyalkyl-carboxylic acids, for example 2,4-D, are combined with cationic polymers of the Mirapol® series from Rhodia GmbH or of the Genamin® series from Clariant GmbH. Mixtures of these combinations with graminicides, for example fenoxaprop-P-ethyl, diclofop-methyl, or clodinafop-propagyl have lower reduced action owing to antagonistic interaction. Further substances which may optionally be present are safeners, other herbicides, adjuvants such as, for example, Genapol® LRO or fertilizers, such as, for example, ammonium sulfate, ammonium hydrogen sulfate, urea or ammonium nitrate.

The percentage of the active compounds in the various formulations can be varied within wide ranges. The formulations comprise, for example, from about 0.01 to 95% by weight of active compounds, about 90-10% by weight of liquid or solid carriers and, if appropriate, up to 50% by weight, preferably up to 30% by weight, of surfactants, where the sum of these percentages should be 100%.

The mixtures, prepared according to the invention, of polymer, one or more active compounds and optional adjuvants and other auxiliaries can also be present as a separate tank mix, and also in other formulations.

Suitable possible formulations are, for example:

wettable powders (WP), water-soluble powders (SP), suspension concentrates (SC) based on oil or water, water-soluble concentrates (SL), emulsifiable concentrates (EC), micro and macro emulsions (EW/ME), such as oil-in-water and water-in-oil emulsions, sprayable solutions, suspension emulsions (SE), oil-miscible solutions, capsule suspensions (CS), dusts (DP), seed-dressing compositions, granules for broadcasting and soil application, granules (GR) in the form of micro granules, spray granules, coating granules and adsorption granules, water-dispersible granules (WDG), water-soluble granules (WSG), ULV formulations, micro capsules and waxes.

These individual formulation types are known in principle and are described, for example, in Winnacker-Küchler, “Chemische Technologie” [Chemical Technology], Volume 7, C. Hanser Verlag Munich, 4th Edition, 1986; Wade van Valkenburg, “Pesticide Formulations”, Marcel Dekker, N.Y., 1973; K Martens, “Spray Drying” Handbook, 3^{rd} Ed. 1979, G. Goodwin Ltd. London.

Formulation auxiliaries, such as inert materials, antifreeze agents, thickeners, surfactants, solvents and other additives, are likewise known and are described, for example, in Watkins, “Handbook of Insecticide Dust Diluents and Carriers”, 2nd Ed., Darland Books, Caldwell N. J., H.v. Olphen, “Introduction to Clay Colloid Chemistry”, 2nd Ed., J. Wiley & Sons, N.Y.; C. Marsden, “Solvents Guide”, 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflachenaktive Äthylenoxidaddukte [Surface-Active Ethylene Oxide Adducts]”, Wiss. Verlagsgesell., Stuttgart 1976; Winnacker-Küchler, “Chemische Technologie”, Volume 7, C. Hanser Verlag Munich, 4th Edition 1986.

Wettable powders are preparations which are uniformly dispersible in water and which contain, in addition to the combination according to the invention and as well as a diluent or inert substance, surfactants of ionic and/or nonionic nature (wetting agents, dispersants), for example polyethoxylated alkyl phenols, polyethoxylated fatty alcohols, polyethoxylated fatty amines, fatty alcohol polyglycol ether sulfates, alkanesulfonates, alkylbenzenesulfonates, sodium lignosulfonate, sodium 2,2′-dinaphthylmethane-6,6′-disulfonate, sodium dibutylnaphthalenesulfonate or else sodium oleoylmethyltaurinate. To prepare the wettable powders, the active compounds are finely ground in customary apparatus such as hammer mills, fan mills or air-jet mills, and are mixed simultaneously or subsequently with the formulation auxiliaries and the polymers used according to the invention.

Emulsifiable concentrates are prepared by dissolving the active compound in combination with the polymer in an organic solvent, for example butanol, cyclohexanone, dimethylformamide, xylene or else relatively high-boiling aromatic compounds or hydrocarbons or mixtures of the organic solvents, with the addition of one or more surfactants of ionic and/or nonionic nature (emulsifiers). Examples of emulsifiers which can be used are calcium alkylarylsulfonates, such as calcium dodecylbenzenesulfonate, or nonionic emulsifiers, such as alkylaryl polyglycol ethers different from para-alkylphenol ethoxylates, fatty acid polyglycol esters, fatty alcohol polyglycol ethers, propylene oxide-ethylene oxide condensation products, alkyl polyethers, sorbitan esters, for example sorbitan fatty acid esters, or polyoxyethylene sorbitan esters, for example polyoxyethylene sorbitan fatty acid esters. Dusts are obtained by grinding the active compound in combination with polymers to be used according to the invention with finely divided solid substances, for example, talc, natural clays, such as kaolin, bentonite and pyrophyllite, or diatomaceous earth.

Suspension concentrates can be water- or oil-based. They can be prepared, for example, by wet milling using commercially customary bead mills, with or without the addition of surfactants as already mentioned above under the other formulation types.

Emulsions, for example oil-in-water emulsions (EW), can be prepared, for example, by means of stirrers, colloid mills and/or static mixers using aqueous organic solvents and, if desired, surfactants, for example as already mentioned above under the other formulation types.

Granules can be prepared either by spraying the active compound in combination with the polymer to be used according to the invention onto adsorptive, granulated inert material or by applying the combination to the surface of carriers, such as sand, kaolinites or of granulated inert material, by means of adhesives, for example sugars, such as pentoses and hexoses or else mineral oils. Suitable active compounds in combination with the polymer to be used according to the invention can also be granulated in the manner which is customary for the preparation of fertilizer granules, if desired as a mixture with fertilizers. Water-dispersible granules are generally prepared by the customary processes, such as spray-drying, fluidized-bed granulation, disk granulation, mixing using high-speed mixers, and extrusion without solid inert material.

For the preparation of disk, fluidized-bed, extruder and spray granules, see, for example, the processes in “Spray-Drying Handbook” 3^{rd} Ed. 1979, G. Goodwin Ltd., London; J. E. Browning, “Agglomeration”, Chemical and Engineering 1967, pages 147 ff.; “Perry's Chemical Engineer's Handbook”, 5^{th} Ed., McGraw-Hill, New York 1973, pp. 8-57.

For further details on the formulation of crop protection products, see, for example, G. C. Klingman, “weed Control as a Science”, John Wiley and Sons, Inc., New York, 1961, pages 81-96 and J. D. Freyer, S. A. Evans, “Weed Control Handbook”, 5^{th} Ed., Blackwell Scientific Publications, Oxford, 1968, pages 101-103.

In addition, said formulations of the combinations according to the invention may comprise the tackifiers, wetting agents, dispersants, emulsifiers, penetrants, preservatives, antifreeze agents, solvents, fillers, carriers, colorants, antifoams, evaporation inhibitors and pH and viscosity regulators which are customary in each case.

Based on these formulations, it is also possible to prepare mixtures with other pesticidally active compounds, such as herbicides, insecticides, fungicides, and also antidotes or safeners, fertilizers and/or growth regulators, for example in the form of a finished formulation or for use as tank mixes.

The combinations according to the invention have outstanding activity. If herbicides are combined with polymers to give the combinations according to the invention, these combinations have excellent herbicidal activity against a broad spectrum of economically important monocotyledonous and dicotyledonous harmful plants. The active compound combinations also act efficiently on perennial weeds which produce shoots from seeds or rhizomes, root stocks or other perennial organs and which are difficult to control. In this context, it is immaterial whether the combinations according to the invention are applied pre-sowing, pre-emergence or post-emergence. The combinations according to the invention are preferably applied onto above-ground parts of plants. The combinations according to the invention are also suitable for dessicating crop plants such as potato, cotton and sunflower.

In the case of herbicidally active compounds, the combinations according to the invention can be used, for example, for controlling the following harmful plants:

dicotyledonous weeds of the genera Sinapis, Galium, Stellaria, Matricaria, Galinsoga, Chenopodium, Brassica, Urtica, Senecio, Amaranthus, Portulaca, Xanthium, Convolvulus, lpomoea, Polygonum, Sesbania, Cirsium, Carduus, Sonchus, Solanum, Lamium, Veronica, Abutilon, Datura, Viola, Monochoria, Commalina, Sphenoclea, Aeschynomene, Heteranthera, Papaver, Euphorbia and Bidens.

Monocotyledonous weeds of the genera Avena, Alopecurus, Echinochloa, Setaria, Panicum, Digitaria, Poa, Eleusine, Brachiaria, Lolium, Bromus, Cyperus, Elytrigia, Sorphum, Apera and Scirpus.

If the herbicidal compositions which comprise the combinations according to the invention are applied prior to germination, then the weed seedlings are either prevented completely from emerging, or the weeds grow until they have reached the cotyledon stage but then their growth stops, and, eventually, after three to four weeks have elapsed, they die completely.

If these herbicidal compositions which comprise the combinations according to the invention are applied post-emergence to the green parts of the plants, growth also stops drastically a very short time after the treatment and the weed plants remain at the development stage of the point in time of application, or they die completely after a certain time, more or less rapidly, so that in this manner competition by the weeds, which is harmful to the crop plants, is eliminated at a very early point in time and in a sustained manner by employing the novel combinations according to the invention, as are associated quantitative and qualitative losses in yield.

Although these combinations according to the invention have excellent herbicidal activity against monocotyledonous and dicotyledonous weeds, damage to the crop plant is insignificant, if there is any damage at all.

These effects permit, inter alia, the application rate to be reduced, a broader spectrum of broad-leaved weeds and weed grasses to be controlled, activity gaps to be closed, also with respect to resistant species, more rapid and safer action, longer duration of action, complete control of the harmful plants using only one or a few applications, and a prolonged application period if a plurality of active compounds are present at the same time.

The abovementioned properties are required for weed control in practice to keep agricultural crops free of undesirable competing plants and to safeguard andlor increase yield quality and quantity. With respect to the properties described, the combinations according to the invention are considerably superior to the prior art.

In addition, the combinations according to the invention permit, in an excellent manner, the control of otherwise resistant harmful plants.

Owing to their agrochemical properties, preferably herbicidal, plant-growth-regulatory and safener properties, the combinations according to the invention, which are preferably employed in herbicidal compositions, can also be employed for controlling harmful plants in crops of known or still to be developed genetically engineered plants. The transgenic plants generally have particularly advantageous properties, for example resistance to certain pesticides, in particular certain herbicides, resistance to plant diseases or causative organisms of plant diseases, such as certain insects or microorganisms such as fungi, bacteria or viruses. Other particular properties relate, for example, to the quantity, quality, storage-stability, composition and specific ingredients of the harvested product. Thus, transgenic plants having an increased starch content or a modified quality of the starch or those having a different fatty acid composition of the harvested product are known.

The use of the combinations according to the invention in economically important transgenic crops of useful and ornamental plants, for example of cereal, such as wheat, barley, rye, oats, millet, rice, manioc and corn, or else in crops of sugar beet, cotton, soya, oilseed rape, potato, pea and other vegetable species is preferred.

The combinations according to the invention with herbicides, plant growth regulators and/or safeners can preferably be used in crops of useful plants which are resistant or which have been made resistant by genetic engineering toward the phytotoxic effects of the herbicides.

Conventional ways for preparing novel plants which have modified properties compared to known plants comprise, for example, traditional breeding methods and the generation of mutants. Alternatively, novel plants having modified properties can be generated with the aid of genetic engineering methods (see, for example, EP-A-0 221 044, EP-A-0 131 624). For example, there have been described several cases of

genetically engineered changes in crop plants in order to modify the starch synthesized in the plants (for example WO 92/11376, WO 92/14827, WO 91/19806),

transgenic crop plants which are resistant to certain herbicides of the glufosinate (cf., for example, EP-A-0 242 236, EP-A-0 242 246) or glyphosate (WO 92/00377) or sulfonylurea (EP-A-0 257 993, U.S. Pat. No. 5,013,659) type,

transgenic crop plants, for example cotton, having the ability to produce Bacillius thuringiensis toxins (Bt toxins) which impart resistance to certain pests to the plants (EP-A-0 142 924, EP-A-0 193 259),

transgenic crop plants having a modified fatty acid composition (WO 91/13972).

Numerous molecular biological techniques which allow the preparation of novel transgenic plants having modified properties are known in principle; see, for example, Sambrook et al., Molecular Cloning, A Laboratory Manual, 2nd Ed. Cold Spring Harbor Laboratory Press, Cold Spring Harbor, NY, or Winnacker “Gene and Kione”, VCH Weinheim 2nd Edition 1996 or Christou, “Trends in Plant Science” 1 (1996) 423431.

In order to carry out such genetic engineering manipulations, it is possible to introduce nucleic acid molecules into plasmids which allow a mutagenesis or a change in the sequence to occur by recombination of DNA sequences. Using the abovementioned standard procedures, it is possible, for example, to exchange bases, to remove partial sequences or to add natural or synthetic sequences. To link the DNA fragments to one another, it is possible to attach adapters or linkers to the fragments.

Plant cells having a reduced activity of a gene product can be prepared, for example, by expressing at least one appropriate antisense-RNA, a sense-RNA to achieve a cosuppression effect, or by expressing at least one appropriately constructed ribozyme which specifically cleaves transcripts of the abovementioned gene product.

To this end, it is possible to employ either DNA molecules which comprise the entire coding sequence of a gene product including any flanking sequences that may be present, or DNA molecules which comprise only parts of the coding sequence, it being necessary for these parts to be long enough to cause an antisense effect in the cells. It is also possible to use DNA sequences which have a high degree of homology to the coding sequences of a gene product but which are not entirely identical.

When expressing nucleic acid molecules in plants, the synthesized protein can be localized in any desired compartment of the plant cell. However, to achieve localization in a certain compartment, it is, for example, possible to link the coding region with DNA sequences which ensure localization in a certain compartment. Such sequences are known to the person skilled in the art (see, for example,

Braun et al., EMBO J. 11 (1992), 3219-3227; Wolter et al., Proc. Natl. Aca. Sci. USA 85 (1988), 846-850; Sonnewald et al., Plant J. 1 (1991), 95-106).

The transgenic plant cells can be regenerated to whole plants using known techniques. The transgenic plants can in principle be plants of any desired plant species, i.e. both monocotyledonous and dicotyledonous plants.

In this manner, it is possible to obtain transgenic plants which have modified properties by overexpression, suppresion or inhibition of homologous (=natural) genes or gene sequences or by expression of heterologous (=foreign) genes or gene sequences.

The combinations according to the invention can preferably be used in transgenic crops which are resistant to herbicides from the group consisting of the sulfonylureas, glufosinate-ammonium or glyphosate-isopropylammonium and analogous active compounds.

When using the combinations according to the invention, in particular those in herbicidal compositions, in transgenic crops, in addition to the effects against harmful plants which can be observed in other crops, there are frequently effects which are specific for the application in the respective transgenic crop, for example a modified or specifically broadened spectrum of weeds which can be controlled; modified application rates which can be used for the application; preferably good miscibility or combinability with those herbicides to which the transgenic crops are resistant; and an effect on the growth and the yield of the transgenic crop plants.

The invention is now additionally illustrated in the examples below.

In all examples, seeds or rhizome pieces of mono- and dicotyledonous harmful plants and useful plants were placed in sandy loam soil in pots having a diameter of 9 - 13 cm and covered with soil. The pots were kept in a greenhouse under optimum conditions. In the two-leaf to three-leaf stage, i.e. about 3 weeks after start of cultivation, the test plants were treated with the combinations according to the invention in the form of aqueous dispersions or suspensions or emulsions and sprayed onto the green parts of the plant at various dosages, using a water application rate of 300 l/ha (converted). For further cultivation of the plants, the pots were kept in the greenhouse under optimum conditions. Visual scoring of the damage to useful plants and crop plants was carried out 2-3 weeks after the treatment.

### EXAMPLE 1

Iodosulfuron-methyl sodium salt (5 g/ha) in combination with Mirapol® A15 (20 g/ha) was applied to crops of wheat and rice. Compared to the application of iodosulfuron-methyl sodium salt (5 glha), increased selectivity and reduced phytotoxicity were observed, at comparable herbicidal action.

### EXAMPLE 2

Iodosulfuron-methyl sodium salt (5 g/ha) was combined with Mirapol® A15 (10 g/ha) and was applied with Genapol® LRO (70%, 300 ml/ha) to crops of wheat and rice. Compared to the application of iodosulfuron-methyl sodium salt (5 g/ha) in a mixture with Genapol® LRO (70%, 300 ml/ha), improved selectivity and reduced phytotoxicity were observed, at comparable herbicidal action.

### EXAMPLE 3

Iodosulfuron-methyl sodium salt (5 g/ha) was applied with Mirapol® A15 (20 g/ha) to crops of rice. Compared to the application of iodosulfuron-methyl sodium salt (5 g/ha) in a mixture with Genapol® LRO (70%, 300 ml/ha), improved selectivity and reduced phytotoxicity were observed, at comparable herbicidal action.

### EXAMPLE 4

Iodosulfuron-methyl sodium salt (5 g/ha) was combined with Mirapol® A15 (50 g/ha) and applied with Genapol® LRO (70%, 300 ml/ha) to crops of wheat and rice. Compared to the application of iodosulfuron-methyl sodium salt (5 g/ha) in a mixture with Genapol® LRO (70%, 300 ml/ha), improved selectivity and reduced phytotoxicity were observed, at comparable herbicidal action.

### EXAMPLE 5

Hussar® OF (1 I/ha) was combined with Mirapol® A15 (50 g/ha) and in a mixture with Genapol® LRO (70%, 300 ml/ha), applied to crops of wheat and rice. Compared to the application of Hussar® OF at a rate of 1 l/ha in a mixture with Genapol® LRO (70%, 300 ml/ha), increased activity and strongly reduced phytotoxicity were observed, and also better selectivity under stress.

### EXAMPLE 6

Titus® (rimsulfuron from Du Pont) (10 g/ha) was combined with Mirapol® A15 (20 g/ha) and applied in a mixture with Genapol® LRO (70%, 300 ml/ha) to crops of corn. Compared to the application of Titus® at a rate of 10 g/ha in combination with Genapol® LRO (70%, 300 ml/ha), a considerably reduced phytotoxicity was observed, at the same action.

### EXAMPLE 7

Titus® (rimsulfuron from Du Pont) (10 g/ha) was combined with Genamin® PDAC (50 g/ha) and applied in a mixture with Genapol® LRO (70%, 300 ml/ha) to crops of corn. Compared to the application of Titus® at a rate of 10 g/ha in combination with Genapol® LRO (70%, 300 ml/ha), a considerably reduced phytotoxicity was observed, at the same action.

### EXAMPLE 8

A mixture of bromoxynil sodium salt (300 g/ha), fenoxaprop-P-ethyl (60 g/ha) and mefenpyr-diethyl ester (15 g/ha) was combined with Mirapol® A15 (300 g/ha) and applied in a mixture with Genapol® LRO (70%, 300 ml/ha) to crops of wheat and rice. Compared to the application of a mixture of bromoxynil sodium salt (300 g/ha), fenoxaprop-P-ethyl (60 g/ha) and mefenpyr-diethyl (15 g/ha) in a mixture with Genapol® LRO (70%, 300 ml/ha), a strongly reduced antagonism, i.e. a considerably improved action at comparable selectivity, was observed.

1. A combination of an anionic agrochemically active compound with a cationic polymer with formation of electrostatic interaction, wherein all or at least some of this polymer is constructed of monomers having cationic groups which contain in particular quaternary nitrogen atoms, where the percentage of monomer units which do not contain any cationic groups, in particular no quaternary nitrogen atoms, is at most 90% by weight, preferably at most 50% by weight, and the molecular weight of the polymers is <10 000 if the quaternary nitrogen atoms are arranged exclusively outside the main chain of the polymer.

2. The combination as claimed in claim 1, wherein the active compound is selected from the group consisting of herbicides, fungicides, insecticides, growth regulators, safeners, molluscicides, acaricides and nematicides, in particular herbicides, growth regulators and safeners.

3. The combination as claimed in claim 2, wherein the herbicides are selected from the group consisting of ALS inhibitors such as sulfonylureas, hydroxy-benzonitriles, preferably bromoxynil and ioxynil, aryloxyalkylcarboxylic acids, preferably MC PA, 2, 4-D, CMPP, 2,4-DP, 2,4-DB, (hetero)aryloxyaryloxy-alkylcarboxylic acids, preferably fenoxaprop-p-ethyl, dichlofop-methyl, clodinafop-propargyl, fluazifop, HPPDO inhibitors, preferably mesotrione or sulcotrione, triazines, and cyclohexanedione oximes, preferably sethoxidim, clethodim or trialkoxidim, the growth regulators are selected from the group consisting of indolylacetic acid, indolylbutyric acid and auxins and the safeners are selected from the group consisting of mefenpyr-diethyl and 5,5-biphenyl-2-isoxazoline-3-carboxylic acid, and their respective derivatives, such as acids, esters and salts.

4. The combination as claimed in claim 3, wherein the sulfonylureas correspond to the formula (V) [chemical structure]
in which M^{⊕} is a suitable cation, preferably an alkali metal ion or an ammonium ion, which may or may not contain organic substituents, most preferably Na, K, ammonium, tetraalkylammonium, tetraalkylolammonium or monoalkylammonium ion,
R′ is hydrogen or a (C₁-C₁₀)-alkyl radical, preferably hydrogen or methyl, R is a radical selected from the group consisting of the compounds corresponding to formulae (Va) to (Vf) 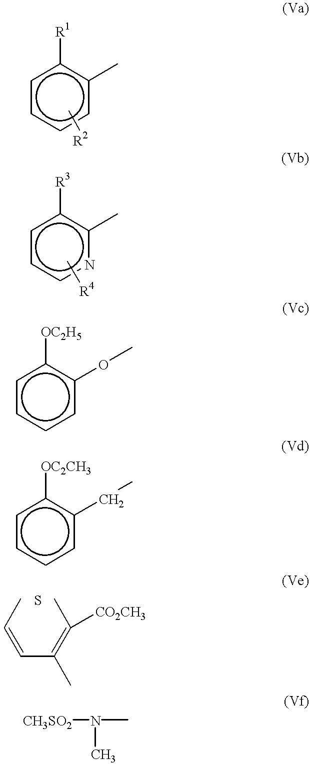
in which R¹ is selected from the group consisting of —CO₂ (C₁-C₁₀-alkyl), CO₂CH₂ 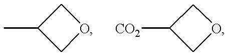
—CO₂N (C₁-C₁₀-alkyl), SO₂(C₁-C₄-alkyl), CF₃, —O(C₁-C₁₀-alkyl), —OCH₂CH₂Cl, CH₂CH₂CF₃, halogen, preferably Cl or F,
R², R³, R⁴, independently of one another are H, CH₃, —OH, —O(C₁-C₁₀-alkyl), —NH(C₁-C₁₀-alkyl), —N(C₁-C₁₀-alkyl)₂, NHCHO, —NHCO₂(C₁-C₂-alkyl), —CH₂NHSO₂CH₃, halogen, preferably F, Cl, Br or I,
Het is a radical of the formula 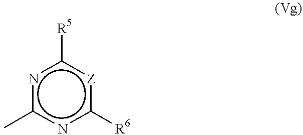
in which R⁵, R⁶ independently of one another are halogen, preferably F or Cl, —O(C₁-C₄-alkyl), C₁-C₄-alkyl, —NH(C₁-C₄-alkyl), —N(C₁-C₄-alkyl)₂, —OCH₂CF₃, —OCHCl₂, and
Z is N or a CH group.

5. The combination as claimed in claim 1, wherein the polymer is soluble, dispersible or emulsifiable in water and/or organic solvents, preferably soluble in polar protic and/or polar aprotic organic solvents and/or water, preferably soluble in water, and has an absorption rate or penetration rate of <50% in 24 h.

6. The combination as claimed in claim 1, wherein the molecular weight of the polymer is about ≧500, preferably about 1 000 to 1 000 000, and the polymer is employed in a weight ratio to the active compound of from about 0.001:1 to about 1:0.001, preferably from 0.01:1 to 1:0.01, most preferably from 0.1:1 to 1:0.1.

7. The combination as claimed in claim 1, wherein the polymer contains monomer units which are selected from the group consisting of the units of the formula (I) [chemical structure]
in which R¹ and R² independently of one another are selected from the group consisting of hydrogen, linear and branched C₁-C₈-alkyl groups, linear and branched C₁-C₅-alkylol groups, cyclopentyl and cyclohexyl groups
and the units of the formula (II) [chemical structure]
in which n is an integer from 1 to 1 0, preferably from 2 to 5, and the substituents R¹ to R³ are independently of one another selected from the group consisting of hydrogen, linear and branched C₁-C₈-alkyl groups, linear and branched C₁-C₅-alkylol groups, cyclopentyl and cyclohexyl groups,
and where X⁻ is the anion of an acid of organic or inorganic origin, preferably a carboxylate, sulfate, carbonate, sulfonate or halide.

8. The combination as claimed in claim 1, wherein the polymer is of the formula (III) [chemical structure]
in which n is an integer from 3 to 50, preferably on average 6,
or of the formula (IV) below [chemical structure]
in which n is an integer from 10 to 200, preferably on average 100, and X⁻ is in each case the anion of an acid of organic or inorganic origin, preferably a carboxylate, sulfate, carbonate, sulfonate or halide.

9. A formulation, comprising a combination as claimed in claim 1 and at least one further component from the group consisting of further agrochemically active compounds, surfactants, fertilizers and customary adjuvants.

10. The formulation as claimed in claim 9, wherein a combination of a herbicide and a polymer is present together with a safener and/or a growth regulator.

11. The use of a combination as claimed in claim 1 or of a formulation as claimed in claim 9 or 10 for suppressing antagonistic interactions during the application of agrochemically active compounds for controlling harmful plants.

12. The use of a combination as claimed in claim 1 or a formulation as claimed in claim 9 or 10 for increasing crop selectivity during the application of one or more agrochemically active compounds for controlling harmful plants.

13. A method for controlling harmful organisms, in particular harmful plants, which comprises applying a combination as claimed in claim 1 or a formulation as claimed in claim 9 or 10.

14. A process for preparing a combination as claimed in claim 1 or a formulation as claimed in claim 9 or 10, which comprises combining the active compound by customary processes which are known per se, preferably by dissolving, stirring or mixing, with a suitable polymer, and introducing this combination into the formulation, if appropriate with other active compounds, adjuvants and additives.
